(19) United States
(12) Patent Application Publication
(10) Pub. No.: US 2013/0282289 A1
(43) Pub. Date: Oct. 24, 2013

(54) AZIMUTHAL SATURATION LOGGING SYSTEMS AND METHODS

(71) Applicants: Amr Lotfy, Cairo (EG); Paul Johnson, Muscat (OM); Frode Hveding, Vinstra (NO)

(72) Inventors: Amr Lotfy, Cairo (EG); Paul Johnson, Muscat (OM); Frode Hveding, Vinstra (NO)

(21) Appl. No.: 13/996,923

(22) PCT Filed: Dec. 22, 2010
(86) PCT No.: PCT/US10/61735

§ 371 Date: Jun. 21, 2013

(51) Int. Cl. G01V 3/38; G01V 11/00

(52) U.S. Cl. CPC G01V 3/38; G01V 11/00
USPC 702/7

(57) ABSTRACT

Logging systems and methods to provide azimuthally-sensitive saturation logs. In some embodiments a processor operates on formation porosity and resistivity measurements from an azimuthally-sensitive logging tool assembly to derive a saturation log having a dependence on tool position and rotation angle, and possibly on radial distance as well. The processor may provide the log to a user via a screen, printer, or some other display mechanism. The logging tool assembly includes at least one tool to measure formation porosity. Suitable tools include a gamma density tool, a neutron density tool, a nuclear magnetic resonance tool, and an acoustic tool. The tool assembly further includes at least one tool to measure formation resistivity. Suitable tools include a laterolog tool, an induction tool, and a propagation resistivity tool. The tool assembly can be a wireline sonde, a tubing-conveyed logging assembly, or a logging while drilling tool assembly.

### BACKGROUND

Modern oil field operators demand access to a great quantity of information regarding the parameters and conditions encountered downhole. Such information typically includes characteristics of the earth formations traversed by the borehole and data relating to the size and configuration of the borehole itself. The collection of information relating to conditions downhole, which commonly is referred to as “logging,” can be performed by several methods including wireline logging and “logging while drilling” (LWD).

In wireline logging, a probe or “sonde” is lowered into the borehole after some or all of the well has been drilled. The sonde bangs at the end of a long cable or “wireline” that provides mechanical support to the sonde and also provides an electrical connection between the sonde and electrical equipment located at the surface of the well In accordance with existing logging techniques, various parameters of the earth's formations are measured and correlated with the position of the sonde in the borehole as the sonde is pulled uphole.

In LWD, the drilling assembly includes sensing instruments that measure various parameters as the formation is being penetrated, thereby enabling measurements of the formation while it is less affected by fluid invasion. While LWD measurements are desirable, drilling operations create an environment that is generally hostile to electronic instrumentation, telemetry, and sensor operations.

In these and other logging environments, measured parameters are usually recorded and displayed in the form of a log, i.e., a two-dimensional graph showing the measured parameter as a function of tool position or depth. In addition to making parameter measurements as a function of depth, some logging tools also provide parameter measurements as a function of azimuth. Such tool measurements have often been displayed as two-dimensional images of the borehole wall, with one dimension representing tool position or depth, the other dimension representing azimuthal orientation, and. the pixel intensity or color representing the parameter value. See, e.g., B. Montaron, U.S. Pat. No. 5,519,668, titled “Methods and devices for real-time formation imaging through measurement while drilling telemetry”. More recently, improved logging tools have been developed that can measure one or more formation parameters as a function of distance from the borehole axis, as well as depth and azimuth. See, e.g., M. Bittar, U.S. patent application Ser. No. 11/835,619, titled “Tool for azimuthal resistivity measurement and bed boundary detection”. Such three-dimensional logs can be displayed in a number of ways, including cutaway perspective, shells, and interactive views. See, e.g., M. Bittar, WO 2008/118735, titled “Systems and Methods for Displaying Logging Data”.

The improved logging and display technology enhances the drillers'understanding of the downhole environment, thereby enabling more accurate steering of the drilling assembly and more cost-effective exploitation of the hydrocarbon reservoirs. However, only a few formation properties are available in two or three-dimensional form. In particular, existing systems and methods for determining fluid saturation logs only provide saturation as a function of depth.

### BRIEF DESCRIPTION OF THE DRAWINGS

A better understanding of the various disclosed embodiments can be obtained when the following detailed description is considered in conjunction with the attached drawings, in which:

FIG. 1 is an illustrative system for azimuthal saturation logging;

FIG. 2 is an illustrative borehole wall image representing a two-dimensional log;

FIG. 3 is an illustrative cutaway perspective view representing a three-dimensional log;

FIG. 4 is a flow diagram of an illustrative azimuthal saturation logging method;

FIG. 5 shows an illustrative azimuthal saturation log; and

FIG. 6 is a block diagram of one portion of an illustrative azimuthal saturation logging system.

While the invention is susceptible to various modifications and alternative forms, specific embodiments thereof are shown by way of example in the drawings and will herein be described in detail. It should be understood, however, that the drawings and detailed description are not intended to limit the disclosure, but on the contrary, the intention is to cover all modifications, equivalents and alternatives falling within the scope of the appended claims.

### DETAILED DESCRIPTION

Accordingly, there are disclosed herein various logging systems and methods that provide azimuthally-sensitive saturation logs. At least some system embodiments include a processor that operates on formation porosity and resistivity measurements from an azimuthally-sensitive logging tool assembly. Based at least in part on those measurements, the processor-derives a saturation log having a dependence on tool position and rotation angle, and possibly on radial distance as well. The processor may provide the log to a user via a screen, printer, or some other display mechanism. The logging tool assembly includes at least one tool to measure formation porosity. Suitable tools include a gamma density tool, a neutron density tool, a nuclear magnetic resonance tool, and an acoustic tool. The tool assembly further includes at least one tool to measure formation resistivity. Suitable tools include a laterolog tool an induction tool, and a propagation resistivity tool. The tool assembly can be a wireline sonde, a tubing-conveyed logging assembly, or a logging while drilling tool assembly.

At least some method embodiments include the acts of: conveying a logging tool assembly along a borehole to obtain measurements indicative of formation porosity and resistivity; processing the measurements to generate a saturation log; and providing the saturation log to a user. As before, the saturation log has a dependence at least on borehole position and azimuthal angle, and may further have a dependence on radial distance. The conveying can be done by coil tubing, a drill string, or a wireline. The resistivity measurements may depend on tool position and azimuthal angle. The porosity measurements can similarly depend on tool position and azimuthal angle, though the azimuthal angle dependence is optional in some embodiments.

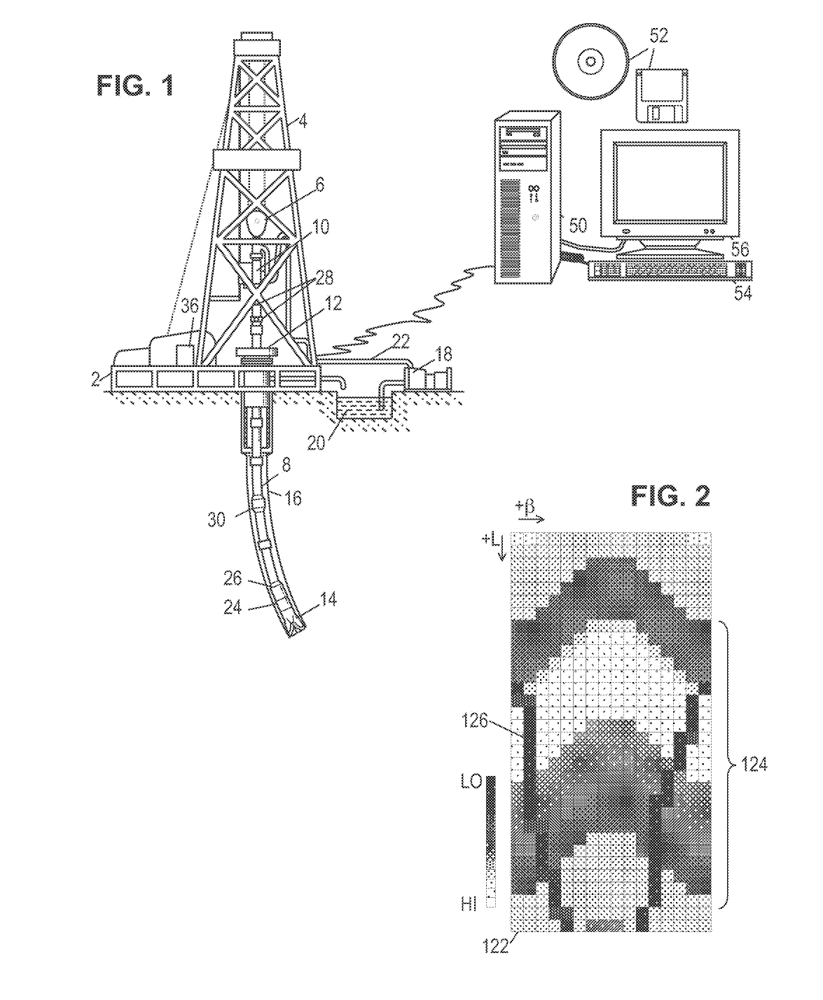

FIG. 1 shows an azimuthal saturation logging system in a drilling environment. A drilling platform 2 supports a derrick 4 having a traveling block 6 for raising and lowering a drill string 8. A top drive 10 supports and rotates the drill string 8 as it is lowered through a well head 12. The drill string's rotation (and/or a downhole motor) turns a drill bit 14 to extend borehole 16. Mud recirculation equipment 18 pumps drilling fluid from a retention pit 20 through a feed pipe 22 to top drive 10, downhole through the interior of drill string 8. through orifices in drill bit 14, back to the surface via the annul us around drill string 8, through a blowout preventer and back into the pit 20. The drilling fluid, transports cuttings from the borehole into the pit 20 and aids in maintaining the borehole integrity.

The bottomhole assembly (i.e., the distal part of drill string 8) includes thick-walled tubulars called drill collars to add weight and rigidity to aid the drilling process. The thick walls of these drill collars make them useful for housing instrumentation and logging while drilling (“LWD”) sensors. Thus, for example, the bottomhole assembly of FIG. 1 includes a tool assembly 23 having a natural gamma ray detector, a resistivity tool, a porosity tool, and a control & telemetry module 26. Other tools and sensors can also be included in the bottomhole assembly to gather measurements of various drilling parameters such as position, orientation, weight-on-bit, borehole diameter, etc. A downhole motor and steering mechanism can also be included in the bottomhole assembly.

The orientation of the bottomhole assembly may be specified in terms of a tool face angle (rotational orientation), an inclination angle (the slope), and compass direction, each of which can be derived from measurements by magnetometers, inclinometers, and/or accelerometers, though other sensor types such as gyroscopes may alternatively be used. In one specific embodiment, the tool includes a 3-axis fluxgate magnetometer and a 3-axis accelerometer. As is known in the art, the combination of those two sensor systems enables the measurement of the tool face angle, inclination angle, and compass direction. Such orientation measurements can be combined with gyroscopic or inertial measurements to accurately track tool position.

As is commonly defined in the art, the inclination angle is the deviation from vertically downward, the horizontal angle (or compass direction) is the angle in a horizontal plane from true North, and the tool face angle is the orientation angle (rotational about the tool axis) from the high side of the borehole. (Since there is no “high side” in a vertical well, the rotational angle in such wells is measured from true North. It is for this reason that the rotational angle is often referred to as the “azimuthal angle”, even in deviated boreholes.)

As the bit extends the borehole through the formations, the LWD tool assembly 24 rotates and collects resistivity and porosity measurements that a downhole controller associates with tool position and orientation measurements to form an azimuthal saturation image map of the borehole wall. Control/telemetry module 26 collects data from the various bottomhole assembly instruments and stores them in internal memory. Selected portions of the data can be communicated to the surface by, e.g., mud pulse telemetry. Other logging-while drilling telemetry methods also exist and could be employed. For example, electromagnetic telemetry or through-wall acoustic telemetry can be employed with an optional repeater 30 to extend the telemetry range. As another example, the drillstring 8 could be formed from wired drillpipe that enables waveforms or images to be transmitted to the surface in real time to enable quality control and processing to optimize the logging resolution. Most telemetry systems also enable commands to be communicated from the surface to the control and telemetry module to configure the operation of the tools.

For mud pulse telemetry, telemetry module 26 modulates a resistance to drilling fluid flow to generate pressure pulses that propagate to the surface. One or more pressure transducers 28 convert the pressure signal into electrical signal(s) for sampling and digitization by computer system 50 or some other form of a data processing device. Computer 50 operates in accordance with software (which may be stored on information storage media 52) and user input received via an input device 54 to process and decode the received signals. The resulting telemetry data may be further analyzed and processed by computer 50 to generate a display of useful information on a computer monitor 56 or some other form of a display device. For example, a driller could employ this system to obtain and view an azimuthal saturation image log.

As previously mentioned, the bottom hole assembly includes a tool that provides measurements indicative of porosity and a tool that provides measurements indicative of resistivity. At least one and possibly both of these tools provide measurements that depend on azimuthal angle to enable a determination of an azimuthal saturation log. As the drill string rotates and extends the borehole, the LWD tools make measurements at various positions and rotational angles, enabling them to form a two-dimensional image of the borehole wall as represented in FIG. 2. Borehole wall image 122 is formed from a grid of pixels, each pixel representing a section of the borehole wall that is some predetermined length as measured along the borehole axis and some predetermined arc length as measured along the borehole circumference. The axial length depends on the tool's speed and vertical resolution and is expected to be in the range from about 0.5 cm to about 15 cm. Similarly, the are length depends on the tool's rotational speed and resolution and is expected to be in the range from about 1° to 60°. The left side of the image traditionally corresponds to a rotational angle of 0° (the top side or north side of the borehole). Each pixel is given a color or other attribute that varies with the measurement value. In this manner, changing formation properties such as porosity or resistivity can be viewed, thereby making different bedding layers 124, faults 126, and other borehole features apparent. Such features often exhibit a sinusoidal dependence on rotational angle, indicating that the borehole encountered the feature at an angle other than 90 degrees.

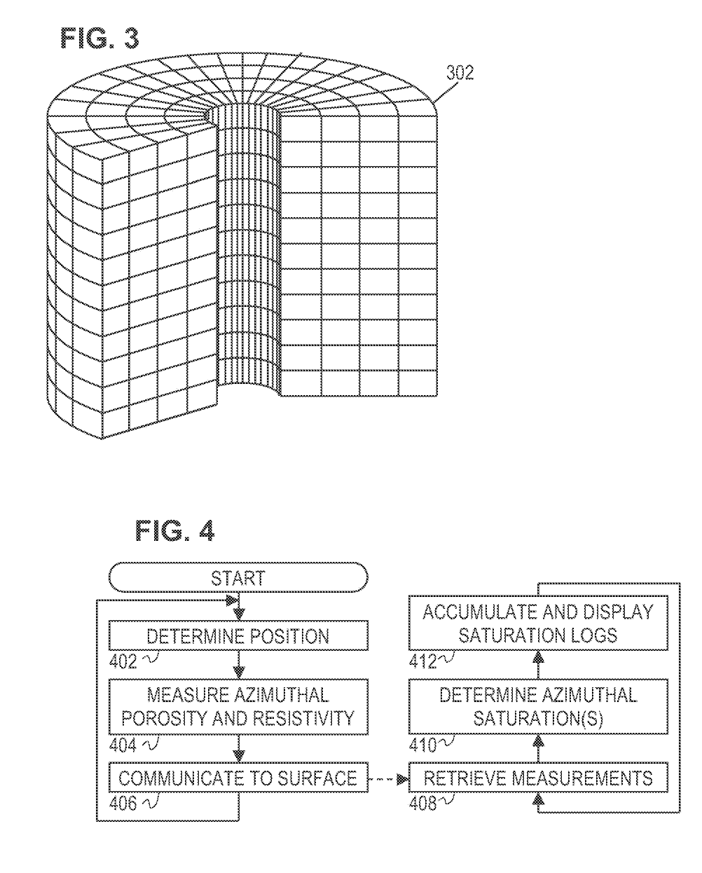

The borehole logs can be extended into a third dimension as illustrated in FIG. 3. To provide this third dimension, at least one of the logging tools 24 provides measurements that depend on radial distance from the borehole axis. The resulting log can be displayed in a variety of forms including a cutaway perspective view 302 such as that shown in FIG. 3. The view 302 is made up of voxels that have a predetermined axial length, a predetermined radial length, and a predetermined circumferential arc length. Each voxel is assigned a color or other attribute indicative of the measurement value. The user may be provided with the opportunity to interact with the three-dimensional model to enhance their understanding of the data volume. Such interaction may, for example, include the ability to rotate, slice, and zoom the model in various ways.

FIG. 4 shows an illustrative azimuthal saturation logging method. Beginning with block 402, the control module determines tool position and orientation using measurements from the navigational package. In block 404, the control module collects and stores porosity and resistivity measurements from the appropriate tools in a manner that associates those measurements with tool position and orientation. In block 406, the control module communicates representative measurements to the surface. The control module repeats the operations of blocks 402-406 for as long as the logging operations continue. In block 408, the surface data acquisition system (computer 50) receives the porosity and resistivity measurements. In block 410, the computer processes the measurements to obtain corresponding azimuthal saturation measurements, and in block 412 the computer updates and displays the azimuthal saturation log data.

A number of tools are suitable for use in obtaining the porosity and resistivity measurements in block 404. Azimuthal porosity measurements can be collected with a gamma ray tool such as the Halliburton Azimuthal Lithodensity (ALD™) Sensor. Such tools monitor the fraction of gamma rays that are reflected from the formation to an axially-spaced receiver. As porosity increases, so too does the average distance traveled by the gamma rays and hence the fraction of reflected rays that reach the receivers. Certain proposed neutron source (and pulsed-neutron source) tools also offer azimuthal porosity measurements. As neutrons enter the formation they scatter inelastically from nuclei and either return to the borehole or get captured by hydrogen nuclei, offering a number of observable phenomena that can be correlated with porosity. For example, inelastic scattering imparts energy to the formation nuclei, which gets re-radiated in the form of a gamma ray. Increasing porosity increases average travel distance and hence may tend to increase the count rate for such gamma rays. Thermal neutron capture by protons (Hydrogen nuclei) causes the emission of gamma rays with a particular energy, enabling the count rate of such gamma rays to serve as an indication of the concentration of hydrogen in the formation. Since the bulk of the hydrogen can be found in the pores of the formation, this count rate can be related to formation porosity. As yet another example, the count rate of scattered neutrons may be indicative of bulk formation density which, when combined with a given matrix density, yields a measure of porosity.

Acoustic tools can also provide azimuthal porosity measurements. Acoustic tools such as Halliburton's QBAT™ Multipole LWD Sonic Tool have receiver arrays that can detect the propagation speed of various acoustic wave modes at various positions around the circumference of the borehole. The various wave modes enable the measurement of compressional and. shear waves speeds. It may be possible to determine porosity based on the relative speeds of compressional and shear waves, since the shear wave speed can drop faster than compressional wave speed as porosity increases.

Azimuthal resistivity measurements can be collected with existing resistivity tools such as Halliburton's InSite AFR™ Azimuthal Focused Resistivity Sensor or Halliburton's InSite ADR™ Azimuthal Deep Resistivity Sensor. Certain Iaterolog tools also offer azimuthal resistivity measurements. Each of the foregoing resistivity tools also offer multiple depths of investigation, thereby permitting resistivity measurements to be made at different radial distances.

To determine saturation from measurements of porosity and resistance in block 410, the computer may employ any appropriate model. The most popular such model is an empirical model known as Archie's law after its originator, Gus Archie, and it represents a whole class of equations that establish similar relationships between water saturation, porosity, and resistivity. Archie's law can be written:

$${( {S}_{w} )}^{n} = \frac{a}{{φ}^{m}} \frac{{R}_{w}}{{R}_{i}} ,$$

where S_{w} is the water saturation (i.e., the fraction of pore space tilled by water), n is the saturation exponent (typically about equal to 2), a is the tortuosity factor (typically taken as equal to 1), φ is porosity, m is cementation exponent (typically in the range from 1.8 to 2.0 for consolidated sandstone), R_{w} is the formation water resistivity (measured separately or estimated), and Rₜ is the measured formation resistivity. Even if some of the parameters are estimated, the resulting log of water saturation still serves as a qualitative indicator of anisotropic saturation characteristics.

Typically the formation pores are fluid filled or gas filled, in fluid filled formations, the oil saturation S_{O} is related to the water saturation by S_{O}=1−S_{W}.

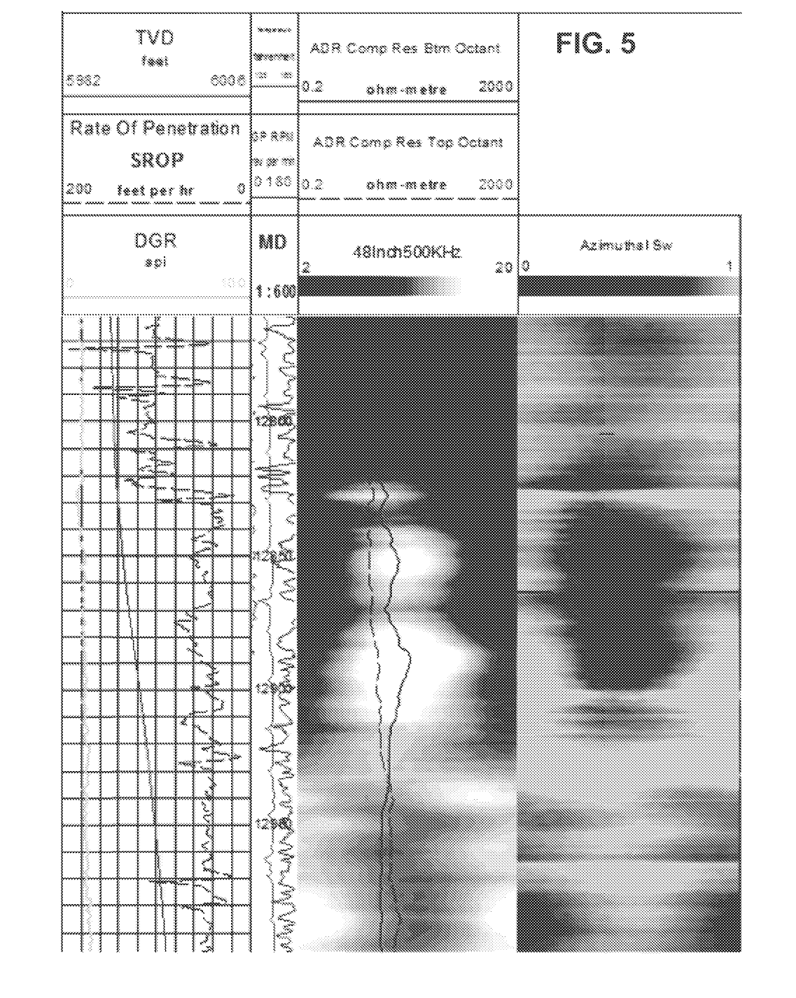

FIG. 5 shows an illustrative set of logs including an azimuthal saturation log that might result from the above-described logging method. The first column shows three curves, including a true vertical depth (TVD) curve, a rate of penetration curve, and a natural gamma ray (DGR) curve. The TVD curve indicates that this 200-ft region of the borehole is mostly horizontal with a gradual descent The rate of penetration curve indicates that the first quarter of this region, is generally softer and easier to drill than the rest. The DGR curve is generally constant and negligible. The second column shows two curves including a temperature curve and a rotations per minute (RFM) curve. The temperature curve shows a generally smooth temperature increase across the region. The RPM curve shows significant variation across the region. The second column further includes a sequence of numeric values representing the measured depth (MD), i.e., the position of the tool along the borehole. The third column shows an azimuthal resistivity image as measured by an induction tool with a 48 inch transmitter-receiver spacing and a signal frequency of 500 kHz. Also shown are two curves of the resistivity along the top of the borehole and along the bottom of the borehole. Finally, the fourth column shows an azimuthal water saturation image. It can be readily observed that significant variation exists in the azimuthal saturation values, probably indicating uneven invasion of water-based borehole fluids into the formation.

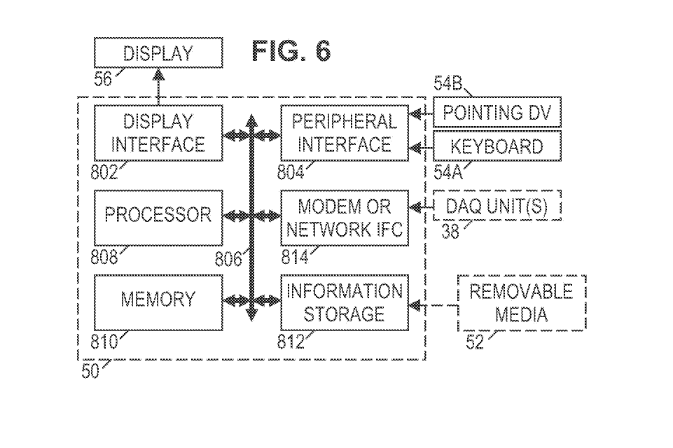

The method of FIG. 4 can be at least partly implemented as software running on a computer system such as that illustrated in FIG. 6. The computer of FIG. 6 includes a chassis 50, a display 56, and one or more input devices 54A, 54B. The chassis 50 is coupled to the display 56 and the input devices 54A, 54B to interact with a user. The display 56 and the input devices 54A, 54B together operate as a user interface. The display 56 often takes the form of a video monitor, but may take many alternative forms suitable for communicating multidimensional log information to a user. The input device 54A is shown as a keyboard, but may similarly take many alternative forms such as pointing devices, joysticks, buttons, motion sensors, a keypad, a camera, a microphone or other means for receiving information from a user.

Located in the chassis 50 is a display interface 802, a peripheral interface 804, a bus 806, a processor 808, a memory 810, an information storage device 812, and a network interface 814. The display interface 802 may take the form of a video card or other suitable interface that accepts information from the bus 806 and transforms it into a form suitable for display 56. Conversely, the peripheral interface may accept signals from input devices 54A, 54B and transform them into a form suitable for communication on bus 806. Bus 806 interconnects the various elements of the computer and transports their communications.

Processor 808 gathers information from the other system elements, including input data from the peripheral interface 804 and program instructions and other data from the memory 810, the information storage device 812, or from a remote location via the network interface 814. (The network interface 814 enables the processor 808 to communicate with remote systems via a wired or wireless network.) The processor 808 carries out the program instructions and processes the data accordingly. The program instructions may further configure the processor 808 to send data to other system elements, including information for the user, which may be communicated via the display interface 802 and the display 56.

The processor 808, and hence the computer as a whole, generally operates in accordance with one or more programs stored on an information storage device 812. One or more of the information storage devices may store programs and data on removable storage media such as a floppy disk or an optical disc 52. Whether or not the information storage media is removable, the processor 808 may copy portions of the programs into the memory 810 for faster access, and may switch between programs or carry out additional programs in response to user actuation of the input device. The additional programs may be retrieved from information the storage device 812 or may be retrieved, from remote locations via the network interface 814. One or more of these programs configures the computer to acquire data from data acquisition unit 38 and carry out at least one of the azimuthal saturation logging methods disclosed herein. In some embodiments, the programs may even configure the computer to generate steering instructions based at least in part on the azimuthal saturation log.

Numerous variations and modifications will become apparent to those skilled in the art once the above disclosure is fully appreciated. For example, the disclosed logging systems and methods have been described in a logging while drilling environment, but they can be readily adapted for use in a wireline or tubing-coveyed logging application. As another example, the disclosed systems and methods split the processing between downhole and surface components, but the processing can be redistributed as desired to perform a greater or lesser degree of processing uphole or downhole, even going so far as to perform all of the processing downhole if desired. It is intended that the following claims be interpreted to embrace all such variations and modifications.

We claim:

1. A logging system that comprises:
a logging tool assembly that provides measurements indicative of formation porosity and resistivity; and
a processor that derives, based at least in part on said measurements, a saturation log having a dependence on tool position and rotation angle.

2. The logging system of claim 1, further comprising a display that shows a representation of said saturation log.

3. The logging system of claim 1, wherein the measurements indicative of formation porosity have a dependence on tool position and rotation angle.

4. The logging system of claim 1, wherein the measurements indicative of resistivity have a dependence on tool position and rotation angle.

5. The logging system of claim 1, wherein the measurements indicative of resistivity have a dependence on radial distance from a borehole axis.

6. The logging system of claim 5, wherein the saturation log further has a dependence on radial distance from the borehole axis.

7. The logging system of claim 1, where saturation log indicates at least one of oil saturation and water saturation.

8. The logging system of claim 1, wherein the logging tool assembly includes an induction or propagation tool to collect said measurements indicative of resistivity.

9. The logging system of claim 1, wherein the logging tool assembly includes a gamma density tool or a neutron density tool to obtain said measurements indicative of formation porosity.

10. The logging system of claim 1, wherein the logging tool assembly includes a nuclear magnetic resonance tool or an acoustic tool to obtain said measurements indicative of formation porosity.

11. The logging system of claim 1, wherein the logging tool assembly is part of a drill string.

12. A logging method that comprises:
conveying a logging tool assembly along a borehole to obtain measurements indicative of formation porosity and resistivity;
processing said measurements to generate a saturation log having a dependence on borehole position and azimuthal angle; and
providing said saturation log to a user.

13. The method of claim 12, wherein said conveying is done with a tubing string or a wireline.

14. The method of claim 12, wherein the measurements indicative of resistivity have a dependence on tool position and azimuthal angle.

15. The method of claim 14, wherein the measurements indicative of resistivity further have a dependence on radial distance from a borehole axis.

16. The method of claim 15, wherein the saturation log further has a dependence on radial distance from the borehole axis.

17. The method of claim 14, wherein the measurements indicative of formation porosity also have a dependence on tool position and azimuthal angle.

18. The method of claim 12, where saturation log indicates at least one of oil saturation and water saturation.

19. The method of claim 12, wherein the logging tool assembly includes an induction tool, a propagation tool, or a laterolog tool to collect said measurements indicative of resistivity.

20. The method, of claim 1, wherein the logging tool assembly obtains said measurements indicative of formation porosity using at least one of a gamma density tool, a neutron density-tool, a nuclear magnetic resonance tool, and an acoustic tool.
